(19) United States
(12) Patent Application Publication
(10) Pub. No.: US 2016/0232607 A1
(43) Pub. Date: Aug. 11, 2016

(54) Tokenized Authorization

(71) Applicant: NewComLink, Inc., Austin, TX (US)

(72) Inventor: Terence Paul Spielman, Austin, TX (US)

(21) Appl. No.: 15/000,517

(22) Filed: Jan. 19, 2016

Related U.S. Application Data
(60) Provisional application No. 62/113,201, filed on Feb. 6, 2015.

(51) Int. Cl. G06Q 40/02

(52) U.S. Cl. CPC G06Q 40/025

(57) ABSTRACT

Some implementations may include a method, a system, or a device to perform operations including receiving, from a consumer, a request to create a shopping pass to purchase items from a retailer; retrieving account information associated with the consumer; determining an account status including a credit limit associated with the account; generating, based on the account status, a token comprising a unique number having at least sixteen digits and an expiry date, the token usable for a single transaction; generating an identification code comprising at least four digits; sending a first message to the consumer that includes the identification code; and sending a second message to the consumer that includes the token.

### CROSS-REFERENCE TO RELATED APPLICATION(S)

This application is a non-provisional of and claims priority to U.S. Provisional Application No. 62/113,201, filed on Feb. 6, 2015, and entitled “Tokenized Authorization” the entirety of which is incorporated herein by this reference thereto.

### BACKGROUND

A retailer may desire to offer consumers access to financing from more than one provider of financing. For example, having more than one lender may enable the retailer to complete more transactions and thereby increase sales. Therefore, the retailer may desire to provide a consumer with a way to easily access a credit account to make a purchase at the retailer.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations may include a method, a system, or a device to perform operations including receiving, from a consumer, a request to create a shopping pass to purchase items from a retailer; retrieving account information associated with the consumer; determining an account status including a credit limit associated with the account; generating, based on the account status, a token comprising a unique number having at least sixteen digits and an expiry date, the token usable for a single transaction; generating an identification code comprising at least four digits; sending a first message to the consumer that includes the identification code; and sending a second message to the consumer that includes the token.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an illustrative architecture that includes interactions between a consumer and a retailer according to some implementations.

FIG. 2 is an illustrative architecture that includes interactions between NCL and a lender according to some implementations.

FIG. 3 is an illustrative architecture that includes interactions between a retailer and NCL according to some implementations.

### DETAILED DESCRIPTION

Systems and techniques are described herein for providing a consumer with access to a credit account to make a purchase at a retailer. An intermediary, referred to herein as NewComLink or NCL, may receive a request to create an account at a lender. The account may enable the consumer to borrow money from the lender to purchase goods, services, or both at a retailer. The consumer may access and authorize the account in several different ways, as described below.

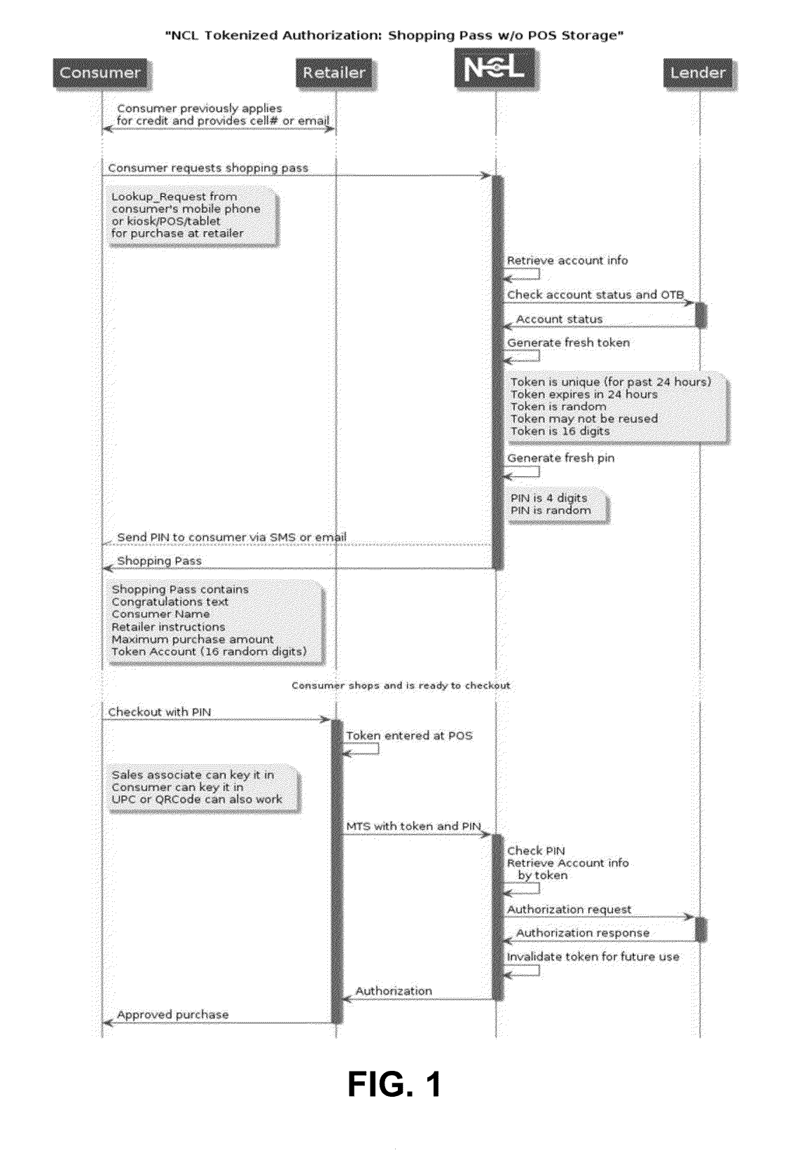

In FIG. 1, the consumer sends an application for a credit account to a retailer. The application includes a cell (e.g., mobile) phone number (or an email address) associated with the consumer. The retailer passes the application to NCL and NCL passes the application to one or more lenders. If the consumer satisfies the lender's criteria for an account, the lender creates an account, associates the account with the consumer, and sends the consumer a message indicating that the request was approved. The lender sends the approval message to the cell phone number (or the email address) of the consumer.

When the consumer desires to make a purchase at the retailer, the consumer requests a shopping pass. The consumer may create the request on the consumer's mobile phone, at a kiosk located in the retailer's premises, at a point of sale (POS) terminal of the retailer, or using another computing device. NCL receives the request, retrieves account information associated with the consumer and sends the request along with the account information to the lender where the consumer has an account. For example, NCL may enable multiple lenders to provide credit accounts to the retailer. The retailer checks the account status to determine whether the consumer is open to buy (OTB), e.g., whether the consumer has an account in good standing and has a credit limit sufficient to allow a purchase. The lender provides the account status to NCL. If NCL determines that the account status satisfies a predetermined set of criteria, NCL approves the request for a shopping pass and generates a fresh (e.g., new) token. The token has several characteristics, e.g., the token is unique within a first particular time period (e.g., 24 hours), the token expires after a second particular time period (e.g., 24 hours), the token is randomly generated (e.g., not predictable by a human or a computer), the token may only be used once (e.g., the token may not be reused), and the token is at least 16 digits (e.g., numerals). NCL generates a fresh (e.g., new) personal identification number (PIN) code. The PIN code is at least 4 digits. In some embodiments, the PIN code may be 6 or 8 digits.

NCL sends the PIN code to the consumer using a short message service (SMS) or other type of message service (e.g., email). For example, NCL may send the PIN code as a text message to the consumer's cell phone or email address that was provided by the consumer when the consumer originally applied for a credit account. In a separate message, NCL sends a shopping pass. Thus, NCL sends two messages, a first message with the PIN code and a second message with the shopping pass. The first message is sent to the consumer. The second message does not include the PIN code. The second message may be sent to the consumer (e.g., in an email) or to the retailer, e.g., for display at a kiosk or POS located at the retailer's premises. The shopping pass includes a congratulatory text (“Congratulations! Here is your shopping pass for up to $X at retailer Y”), the consumer's name, instructions to the retailer on how to process the shopping pass, a maximum available purchase amount, and the token (e.g., 16 or more digits identifying the account number).

The consumer shops at the retailer and then is ready to checkout. The consumer provides the PIN code that was included in the first message. For example, the consumer may display a bar code, a quick response (QR) code, or other scannable code on the consumer's cell phone and the retailer may scan the code to enter the PIN code into the retailer's POS. As another example, the consumer may enter the PIN code (e.g., without the PIN code being exposed to others) into the retailer's POS, e.g., using a debit card scanner that enables a user to enter a PIN code. As yet another example, the consumer may provide the code to an employee of the retailer and the employee may enter the PIN code into the retailer's POS.

The token from the shopping pass is entered into the retailer's POS by the consumer or by an employee (e.g., sales associate) of the retailer. In some cases, the token may be entered by displaying a scannable code from the shopping pass. For example, the consumer may display a scannable code (e.g., QR code, bar code or the like) on the consumer's cell phone and the retailer may scan the scannable code to enter the token into the retailer's POS. To illustrate, the scannable code may be (i) included in an email or (ii) an image sent via a text message to the consumer's cell phone and the consumer may display the email or image on the cell phone.

The token and PIN code are sent from the retailer's POS to NCL. NCL receives the token and PIN code, authenticates the PIN code, retrieves the account information for the consumer's account using the token, and sends an authorization request to the lender. The authorization request includes information associated with the transaction, such as an identity of the consumer's account, an amount of the transaction, the identity of the retailer, and other transaction-related information. The lender authenticates the requests and determines whether the transaction satisfies various criteria, such as whether approving the transaction would cause the account's credit limit to be exceeded, etc. The lender provides an authorization response to NCL in which the lender either authorizes the transaction or declines the transaction based on whether the transaction satisfies the various criteria. After receiving the authorization response, NCL invalidates the token to prevent future use of the token, provides an indication as to whether the transaction was approved or declined to the retailer, and if the transaction was approved by the lender, the retailer indicates that the purchase was approved and the purchase is completed.

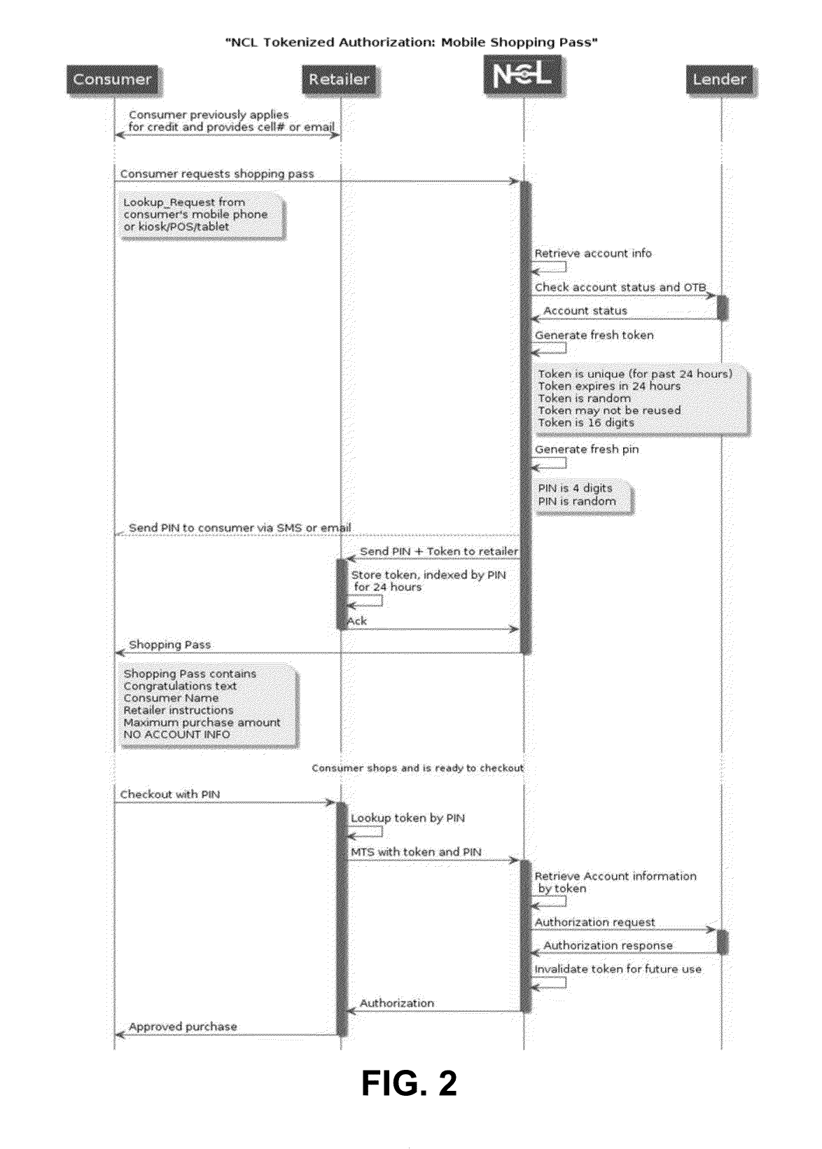

In FIG. 2, the consumer sends an application for a credit account to a retailer. The application includes a cell (e.g., mobile) phone number (or an email address) associated with the consumer. The retailer passes the application to NCL and NCL passes the application to one or more lenders. If the consumer satisfies the lender's criteria for an account, the lender creates an account, associates the account with the consumer, and sends the consumer a message indicating that the request was approved. The lender sends the approval message to the cell phone number (or the email address) of the consumer.

When the consumer desires to make a purchase at the retailer, the consumer requests a shopping pass. The consumer may create the request on the consumer's mobile phone, at a kiosk located in the retailer's premises, at a point of sale (POS) terminal of the retailer, or using another computing device. NCL receives the request, retrieves account information associated with the consumer and sends the request along with the account information to the lender where the consumer has an account. For example, NCL may enable multiple lenders to provide credit accounts to the retailer. The retailer checks the account status to determine whether the consumer is open to buy (OTB), e.g., whether the consumer has an account in good standing and has a credit limit sufficient to allow a purchase. The lender provides the account status to NCL. If NCL determines that the account status satisfies a predetermined set of criteria, NCL approves the request for a shopping pass and generates a fresh (e.g., new) token. The token has several characteristics, e.g., the token is unique within a first particular time period (e.g., 24 hours), the token expires after a second particular time period (e.g., 24 hours), the token is randomly generated (e.g., not predictable by a human or a computer), the token may only be used once (e.g., the token may not be reused), and the token is at least 16 digits (e.g., numerals). NCL generates a fresh (e.g., new) personal identification number (PIN) code. The PIN code is at least 4 digits. In some embodiments, the PIN code may be 6 or 8 digits.

NCL sends the PIN code to the consumer in a first message, e.g., a short message service (SMS) or other type of message service (e.g., email). For example, NCL may send the PIN code as a text message to the consumer's cell phone or email address that was provided by the consumer when the consumer originally applied for a credit account.

NCL sends a second message to the retailer that includes the PIN code and the token, to inform the retailer that the consumer intends to come to shop at the retailer. The retailer stores the token and the PIN code for 24 hours. For example, the retailer may enter the token and PIN code into the POS.

In a third message, NCL sends (e.g., via email, text, etc.) a shopping pass to the consumer. The shopping pass includes a congratulatory text (“Congratulations! Here is your shopping pass for up to $X at retailer Y”), the consumer's name, instructions to the retailer on how to process the shopping pass, and a maximum available purchase amount. The shopping pass does not include information associated with the consumer's account, e.g., the shopping pass does not include the token and the PIN code.

The consumer shops at the retailer and then is ready to checkout. The consumer provides the PIN code that was included in the first message. For example, the consumer may display a bar code, a quick response (QR) code, or other scannable code on the consumer's cell phone and the retailer may scan the code to enter the PIN code into the retailer's POS. As another example, the consumer may enter the PIN code (e.g., without the PIN code being exposed to others) into the retailer's POS, e.g., using a debit card scanner that enables a user to enter a PIN code. As yet another example, the consumer may provide the code to an employee of the retailer and the employee may enter the PIN code into the retailer's POS.

The POS uses the PIN code to retrieve the token. The token and PIN code are sent from the retailer's POS to NCL. NCL receives the token and PIN code, authenticates the PIN code, retrieves the account information for the consumer's account using the token, and sends an authorization request to the lender. The authorization request includes information associated with the transaction, such as an identity of the consumer's account, an amount of the transaction, the identity of the retailer, and other transaction-related information. The lender authenticates the requests and determines whether the transaction satisfies various criteria, such as whether approving the transaction would cause the account's credit limit to be exceeded, etc. The lender provides an authorization response to NCL in which the lender either authorizes the transaction or declines the transaction based on whether the transaction satisfies the various criteria. After receiving the authorization response, NCL invalidates the token to prevent future use of the token, provides an indication as to whether the transaction was approved or declined to the retailer, and if the transaction was approved by the lender, the retailer indicates that the purchase was approved and the purchase is completed.

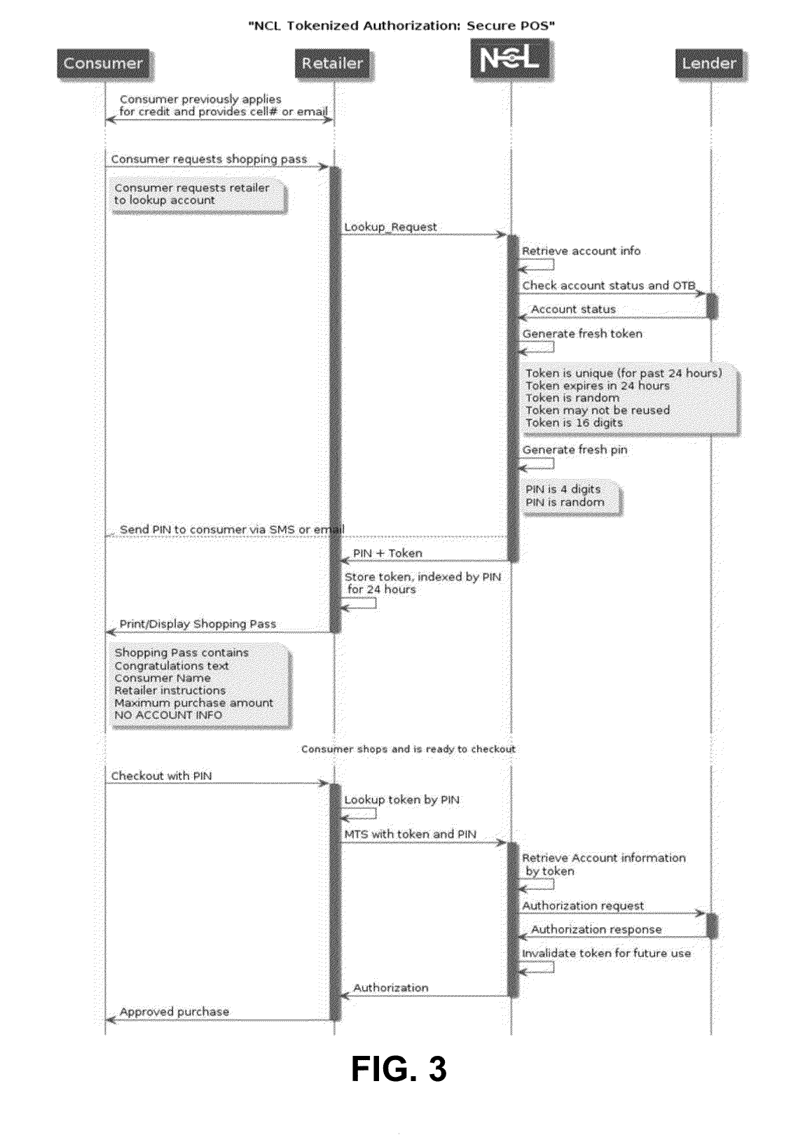

In FIG. 3, the consumer sends an application for a credit account to a retailer. The application includes a cell (e.g., mobile) phone number (or an email address) associated with the consumer. The retailer passes the application to NCL and NCL passes the application to one or more lenders. If the consumer satisfies the lender's criteria for an account, the lender creates an account, associates the account with the consumer, and sends the consumer a message indicating that the request was approved. The lender sends the approval message to the cell phone number (or the email address) of the consumer.

When the consumer desires to make a purchase at the retailer, the consumer goes to the retailer's premises and requests a shopping pass (e.g., via a kiosk, a POS, an application installed on the consumer's cell phone, etc.). The shopping pass request is sent from the retailer to NCL. NCL receives the request, retrieves account information associated with the consumer and sends the request along with the account information to the lender where the consumer has an account. For example, NCL may enable multiple lenders to provide credit accounts to the retailer. The retailer checks the account status to determine whether the consumer is open to buy (OTB), e.g., whether the consumer has an account in good standing and has a credit limit sufficient to allow a purchase. The lender provides the account status to NCL. If NCL determines that the account status satisfies a predetermined set of criteria, NCL approves the request for a shopping pass and generate a fresh (e.g., new) token. The token has several characteristics, e.g., the token is unique within a first particular time period (e.g., 24 hours), the token expires after a second particular time period (e.g., 24 hours), the token is randomly generated (e.g., not predictable by a human or a computer), the token may only be used once (e.g., the token may not be reused), and the token is at least 16 digits (e.g., numerals). NCL generates a fresh (e.g., new) personal identification number (PIN) code. The PIN code is at least 4 digits. In some embodiments, the PIN code may be 6 or 8 digits.

NCL sends the PIN code to the consumer using a first message (e.g., SMS, email, etc.). For example, NCL may send the PIN code as a text message to the consumer's cell phone or email address that was provided by the consumer when the consumer originally applied for a credit account.

NCL sends a second message to the retailer that includes the PIN code and the token, to inform the retailer that the consumer intends to come to shop at the retailer. The retailer stores the token and the PIN code for 24 hours. For example, the retailer may enter the token and PIN code into the POS.

In a third message, NCL sends (e.g., via email, text, etc.) a shopping pass to the consumer. The shopping pass includes a congratulatory text (“Congratulations! Here is your shopping pass for up to $X at retailer Y”), the consumer's name, instructions to the retailer on how to process the shopping pass, and a maximum available purchase amount. The shopping pass does not include information associate with the consumer's account, e.g., the shopping pass does not include the token and the PIN code. The user may print or display the shopping pass during a purchase.

The consumer shops at the retailer and then is ready to checkout. The consumer provides the PIN code that was included in the first message. For example, the consumer may display a bar code, a quick response (QR) code, or other scannable code on the consumer's cell phone and the retailer may scan the code to enter the PIN code into the retailer's POS. As another example, the consumer may enter the PIN code (e.g., without the PIN code being exposed to others) into the retailer's POS, e.g., using a debit card scanner that enables a user to enter a PIN code. As yet another example, the consumer may provide the code to an employee of the retailer and the employee may enter the PIN code into the retailer's POS.

The POS uses the PIN code to retrieve the token. The token and PIN code are sent from the retailer's POS to NCL. NCL receives the token and PIN code, authenticates the PIN code, retrieves the account information for the consumer's account using the token, and sends an authorization request to the lender. The authorization request includes information associated with the transaction, such as an identity of the consumer's account, an amount of the transaction, the identity of the retailer, and other transaction-related information. The lender authenticates the requests and determines whether the transaction satisfies various criteria, such as whether approving the transaction would cause the account's credit limit to be exceeded, etc. The lender provides an authorization response to NCL in which the lender either authorizes the transaction or declines the transaction based on whether the transaction satisfies the various criteria. After receiving the authorization response, NCL invalidates the token to prevent future use of the token, provides an indication as to whether the transaction was approved or declined to the retailer, and if the transaction was approved by the lender, the retailer indicates that the purchase was approved and the purchase is completed.

The primary difference between FIG. 2 and FIG. 3 is that in FIG. 2 the consumer may perform some actions prior to going to the retailer's premises whereas in FIG. 3 the actions are performed at the retailer's premises.

What is claimed is:

1. A method, system, and device to perform operations comprising:
receiving, from a consumer, a request to create a shopping pass to purchase items from a retailer;
retrieving account information associated with the consumer;
determining an account status including a credit limit associated with the account;
generating, based on the account status, a token comprising a unique number having at least sixteen digits and an expiry date, the token usable for a single transaction;
generating an identification code comprising at least four digits;
sending a first message to the consumer that includes the identification code; and
sending a second message to the consumer that includes the token.

2. The method, system, and device of claim 1, the operations further comprising:
receiving, from a retailer, a transaction initiation request that includes the token, the identification code, and an amount of a transaction;
retrieving the account information based on the token;
sending, to a lender, an authorization request that includes the account information and the amount of the transaction;
receiving, from the lender, an authorization response indicating whether the transaction was approved or declined; and
sending, to the retailer, a transaction response based on the authorization response.

3. A method, system, and device to perform operations comprising:
receiving, from a consumer, a request to create a shopping pass to purchase items from a retailer;
retrieving account information associated with the consumer;
determining an account status including a credit limit associated with the account;
generating, based on the account status, a token comprising a unique number having at least sixteen digits and an expiry date, the token usable for a single transaction;
generating an identification code comprising at least four digits;
sending a first message to the consumer that includes the identification code;
sending a second message to the retailer that includes the token and the identification code; and
sending a third message to the consumer that includes the token.

4. The method, system, and device of claim 3, the operations further comprising:
receiving, from a retailer, a transaction initiation request that includes the token, the identification code, and an amount of a transaction;
retrieving the account information based on the token;
sending, to a lender, an authorization request that includes the account information and the amount of the transaction;
receiving, from the lender, an authorization response indicating whether the transaction was approved or declined; and
sending, to the retailer, a transaction response based on the authorization response.
